(19) United States
(12) Patent Application Publication
(10) Pub. No.: US 2013/0074988 A1
(43) Pub. Date: Mar. 28, 2013

(54) TOOLREST MECHANISM FOR WOOD TURNING LATHE

(71) Applicant: Calvin CHOU, Taichung City (TW)

(72) Inventor: Calvin CHOU, Taichung City (TW)

(21) Appl. No.: 13/243,598

(22) Filed: Sep. 23, 2011

(51) Int. Cl. B27C 7/06

(52) U.S. Cl. 142/49

(57) ABSTRACT

A toolrest mechanism for a wood turning lathe includes a banjo, a carriage, a first threaded element, a second threaded element and a toolrest. The carriage is divided into two clamping elements facing each other by a slot formed therebetween, and the clamping elements can be drawn together by operating the threaded elements, so as to adjust the carriage from an initial, release position toward a clamping position. The toolrest has a toolrest portion and a shaft. The shaft is allowed to move axially within the slot while the carriage is at the release position, and the shaft is disallowed to move axially within the slot while the carriage is at the clamping position.

### BACKGROUND OF THE INVENTION

1. Technical Field

The present invention relates to wood turning lathes, and more particularly to a toolrest mechanism provided to a wood turning lathe for supporting a manual tool to tool a workpiece turning on the lathe.

2. Description of Related Art

A wood turning lathe is a machine rotating a wood workpiece with its spindle. As shown in FIG. 1, the lathe substantially has a lathe bed 1, a headstock 2, a tailstock 3, a power source 4, a speed-changing mechanism 5 coupled to the spindle for turning the workpiece, and a toolrest mechanism 6. The headstock 2 and the tailstock 3 are disposed on both sides of the lathe bed 1 respectively and can support a wood workpiece affixed therebetween. The spindle of the headstock 2 is powered by the power source 4 via the speed-changing mechanism 5 to rotate the workpiece. At this time, a worker can manually hold a cutting tool and rest the tool against the toolrest mechanism 6 in order to stably tool the workpiece rotating at a high speed.

Please further refer to FIGS. 2 and 3. The toolrest mechanism 6 includes a banjo 7 spanning across the lathe bed 1, a carriage 8 and a toolrest 9. The toolrest 9 is vertically movable with respect to the carriage 8, and can be positioned at a desired altitude using a threaded bolt 10 selectively abutting against a shaft 11 of the toolrest 9. However, since the force such applied acts unilaterally on the shaft 11 when the bolt 10 is fully screwed toward the shaft 11, the engagement of the carriage 8 to the toolrest 9 is not stable and tends to fail when the toolrest mechanism 6 receives a counterforce from the tooled workpiece via the manual tool that exceeds the maximum load of the friction between the shaft 11 and the bolt 10. In such a case, the toolrest 9 released by the carriage 8 may suddenly drop inward the carriage 8 or rotate. Either of such undesirable movements of the toolrest 9 can risk the worker from cutting his/her hand with the tool.

### SUMMARY OF THE INVENTION

In view of the unstableness of the prior-art device as described above, the present invention herein provides a toolrest mechanism for a wood turning lathe with improved reliability.

According to the present invention, a toolrest mechanism includes a banjo, a carriage, a first threaded element, a second threaded element and a toolrest. The banjo is adapted to span across a lathe bed. The carriage is vertically disposed on the banjo and centrally has a top-opened slot extending through it widthwise so that at least an upper part of the carriage is split by the slot into a pair of parallel clamping elements facing each other. A retaining socket is formed at a center of the carriage and extends vertically along the slot. Against the retaining socket, each of the clamping elements is divided into a first flank and a second flank. One of the first flanks facing each other is formed with a first through hole and the other is formed with a first threaded bore, wherein the first through hole and the first threaded bore are aligned with each other. Similarly, the second flanks are formed with a second through hole and a second threaded bore, respectively. A first threaded element is configured to pass through the first through hole and then engage with the first threaded bore. As the first threaded element screws into the first threaded bore, the first flanks are brought together and the retaining socket is reduced in diameter. A second threaded element is configured to couple the two second flanks and deform the diameter of the retaining socket in the same way. Thus, by screwing at least one of the first and second threaded elements, the carriage can be adjusted to a clamping position from an initial, release position. The toolrest has a substantially horizontal toolrest portion and a shaft extending downward from the toolrest portion. The shaft is to be at least partially received in the retaining socket so as to uphold the toolrest portion over the carriage. When the carriage is in the release position, the shaft is allowed to move axially and rotationally within the retaining socket while when the carriage is in the clamping position, the deformed retaining socket retains the shaft from moving axially and rotationally with respect to the carriage.

Thus the primary objective of the present invention is achieved by the retaining force applied to the shaft of the toolrest circumferentially via a periphery of the retaining socket from the clamping elements. When tightly sandwiched between the clamping elements, the shaft of the toolrest receives a bilateral pressure instead of single-pointed pressure as implemented in the prior art, so the toolrest can be firmly supported. By using different embodiments of the present invention, the unstable engagement can thus be obviated or at least improved.

### BRIEF DESCRIPTION OF THE DRAWINGS

The invention as well as a preferred mode of use, further objectives and advantages thereof will be best understood by reference to the following detailed description of illustrative embodiment when read in conjunction with the accompanying drawings, wherein:

FIG. 1 is a perspective view of a conventional wood turning lathe;

FIG. 2 is a perspective view of a toolrest mechanism of the prior art;

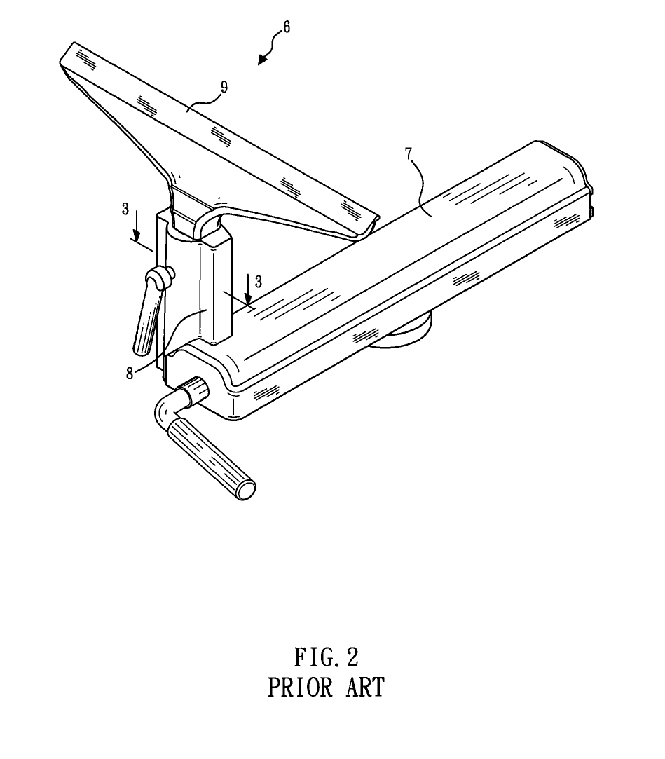

FIG. 3 is a partial 3-3 profile of FIG. 2;

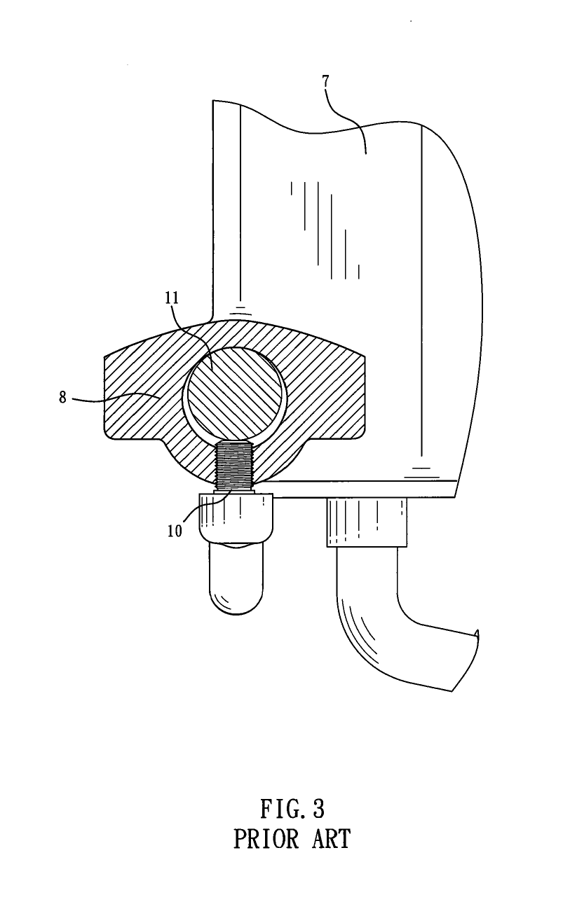

FIG. 4 is a perspective view of a toolrest mechanism for a wood turning lathe according to the present invention;

FIG. 5 is an explosive drawing of the toolrest mechanism of the present invention;

FIG. 6 is a side view of the toolrest mechanism of the present invention; and

FIG. 7 is a partial 7-7 profile of FIG. 6.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

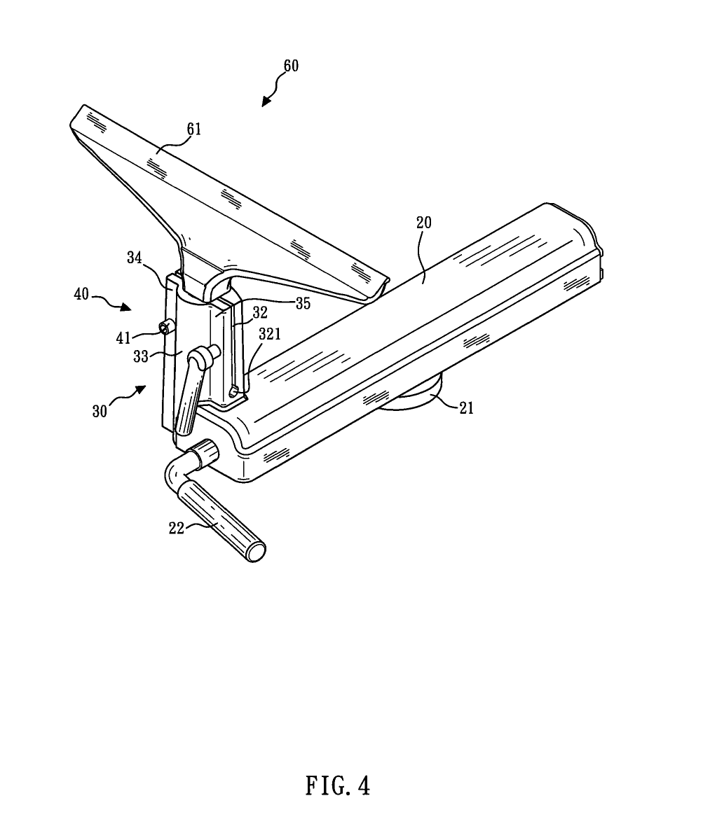

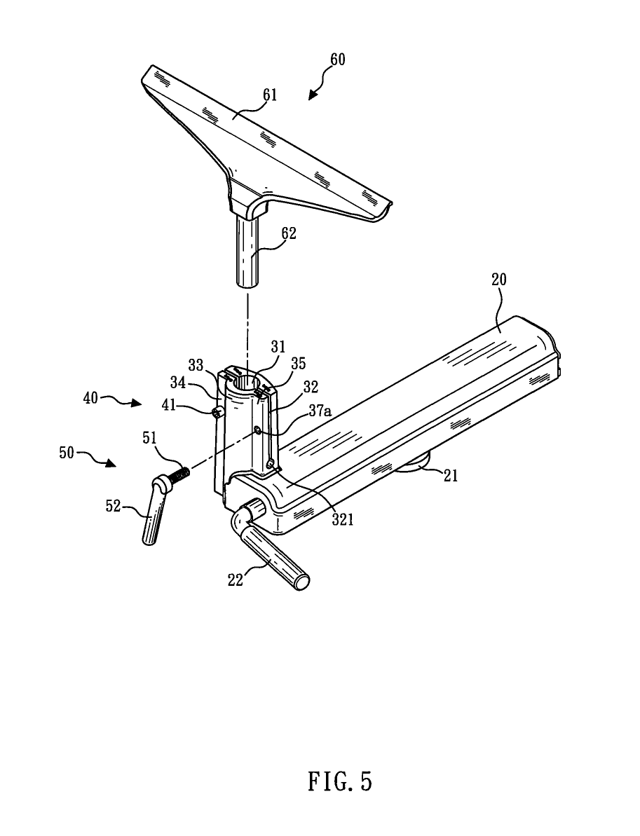

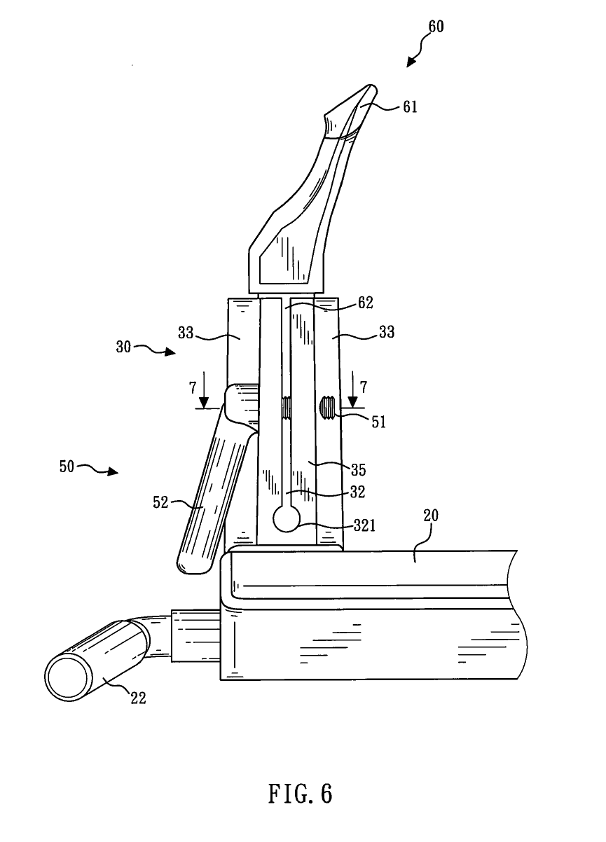

Please refer to FIGS. 4-7. According to one preferred embodiment of the present invention, a toolrest mechanism for a wood turning lathe includes a banjo 20, a carriage 30, a first threaded element 40, a second threaded element 50 and a toolrest 60.

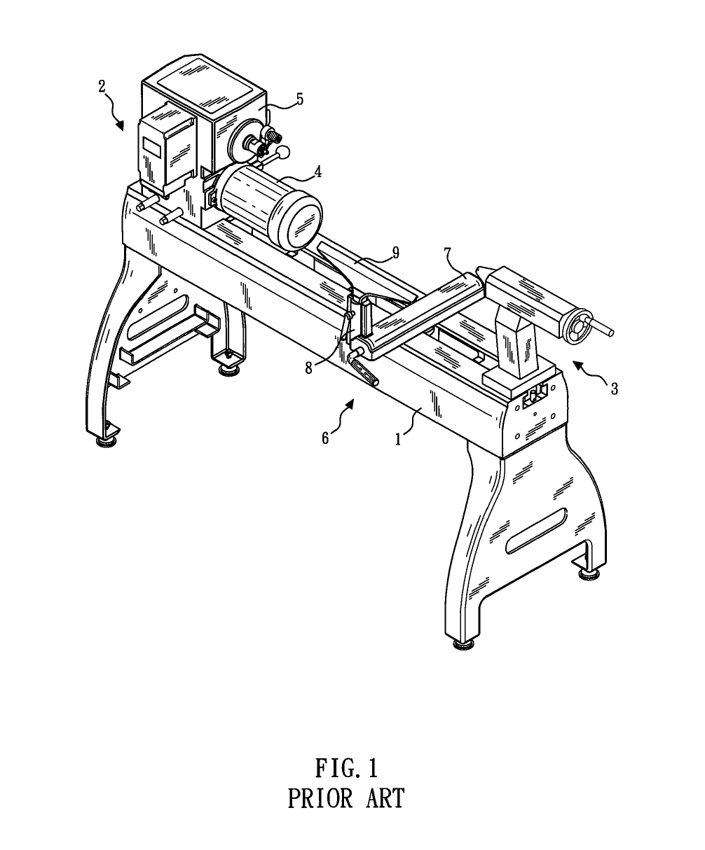

The banjo 20 is adapted to sit across a lathe bed 1 of the wood turning lathe, as that shown in FIG. 1. Preferably, the banjo 20 is slidable along the length direction of the lathe bed 1, and a sliding cam 21 can be further provided beneath the banjo 20. The sliding cam 21 can be actuated by a lever 22 so as to selectively affix the banjo 20 on the lathe bed 1.

The carriage 30 is vertically disposed on the banjo 20 and centrally has a top-opened slot 32 extending through it widthwise so that at least an upper part of the carriage is split by the slot 32 into a pair of parallel clamping elements 33 facing each other. Preferably, the slot 32 has its bottom formed as a circular groove 321 whose diameter is greater than a width of the rest part of the slot 32, or the distance between the clamping elements 33, such that the laterally resilient deformation of the clamping elements 33 can be enlarged and stress concentration does not occur at the bottom of the slot 32.

A retaining socket 31 is formed at a center of the carriage 30 and extends vertically along the slot 32. Against the retaining socket 31, each of the clamping elements is divided into a first flank 34 and a second flank 35. One of the first flanks 34 facing each other is formed with a first through hole 36a and the other is formed with a first threaded bore 36b, wherein the first through hole 36a and the first threaded bore 36b are aligned with each other. Similarly, the second flanks 35 are formed with a second through hole 37a and a second threaded bore 37b, respectively. Preferably, the holes and bores 36a, 36b, 37a, 37b are located corresponding to the center of the vertical length of the slot 32.

The first threaded element 40 is configured to pass through the first through hole 36a and then engage with the first threaded bore 36b. As the first threaded element 40 screws into the first threaded bore 36b, the first flanks 34 are brought together and the retaining socket 31 is reduced in diameter. A second threaded element 50 is configured to couple the two second flanks 35 and deform the diameter of the retaining socket 31 in the same way. The first threaded element 40 preferably has a nut 41 formed with a hexagonal bore, such that the first threaded element 40 can be screwed to adjust a depth the first threaded element 40 extends into the first threaded bore 36b. However, the first threaded element 40 is usually not adjusted while there is a need to adjust the height and position of the toolrest 60 during woodworking. In other alternating embodiments of the present invention, the first threaded element 40 can further include a handle so as to be easily adjusted. In other alternating embodiments of the present invention, a nut can be provided on one side of a flank 34 or 35 and threaded with the threaded element 40 or 50. Thus no thread is necessary in the threaded bores while urging both flanks toward each other.

The second threaded element 50 has a threaded section 51 and a handle 52 extended from the threaded section 51. As the threaded section 51 passes through the second through hole 37a and is screwed into the second threaded bore 37b, the second flanks 35 are drawn together and the carriage 30 is adjusted toward a clamping position from an initial, release position. Moreover, an included angle is defined between the threaded section 51 and the handle 52, and preferably the included angle is between 100 and 110 degrees that the user can easily apply torque thereon.

The toolrest 60 has a substantially horizontal toolrest portion 61 and a shaft 62 extending downward from the toolrest portion 61. The toolrest portion 61 is adapted for cutting tools to abut thereagainst, thus the cutting tools can be manually operated to slide along the toolrest portion 61 during woodworking. The shaft 62 is to be at least partially received in the retaining socket 31 so as to uphold the toolrest portion 61 over the carriage 30.

While the carriage 30 is at the release position, the shaft 62 is allowed to move axially within the retaining socket 31. Preferably, the retaining socket 31 has a circular periphery for facilitating rotation of the shaft 62 within the retaining socket 31 while the carriage 30 is at the release position. As such, the toolrest 60 can be adjusted into desired angular position or altitude.

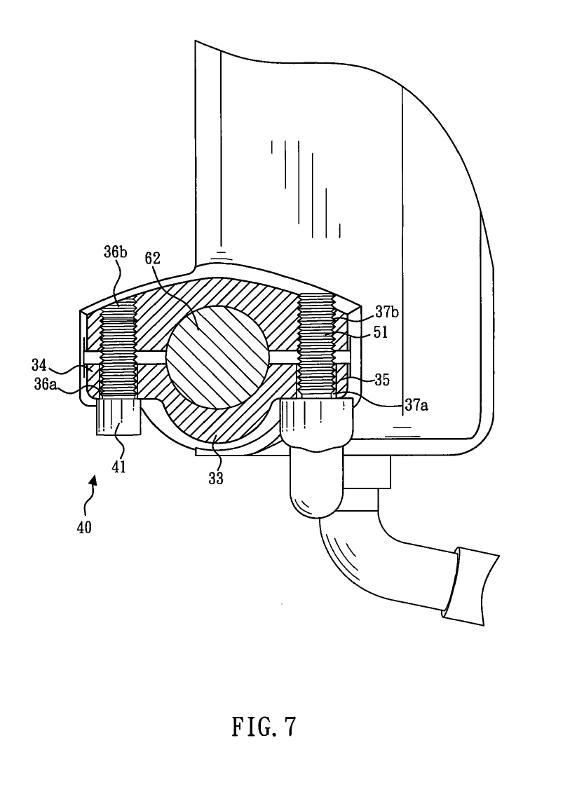

On the other hand, as shown in FIG. 7, the shaft 62 is clamped by the clamping elements 33 in a side-to-side clamping engagement manner while the carriage 30 is at the clamping position, such that the shaft 62 can neither axially move nor rotate within the retaining socket 31. Thus the toolrest 60 can be supported stationarily.

In summarization, the toolrest mechanism of the present invention is adapted to solve the disadvantage that the toolrest may move unexpectedly while it is pressed axially or in the rotatary direction during woodworking. The toolrest the prior art provided is mainly supported in a point-to-point abutting manner, but the friction force produced is not sufficient to bear the force, either axial force or torque, from the toolrest, and thus there are safety concerns regarding the operation of the lathe machine using the toolrest mechanism of the prior art. On the contrary, by using the side-to-side circumferential clamping manner, the toolrest of the present invention is much more stationarily supported to against the axial force and the torque during tooling. The operation safety is, therefore, significantly improved.

The present invention has been described with reference to the preferred embodiments and it is understood that the embodiment are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A toolrest mechanism for a wood turning lathe, comprising:
a banjo, being adapted to span across a lathe bed of the wood turning lathe;
a carriage, being vertically disposed on the banjo, and centrally having a top-opened slot extending through the carriage widthwise so that at least an upper part of the carriage is split by the slot into a pair of parallel clamping elements facing each other, a retaining socket being defined at a center of the carriage and extends vertically along the slot such that against the retaining socket, each of the clamping elements is divided into a first flank and a second flank, the first flanks having aligned a first through hole and a first threaded bore, respectively, and the second flanks having aligned a second through hole and a second threaded bore, respectively;
a first threaded element, being configured to pass through the first through hole and then engage with the first threaded bore, such that as the first threaded element is screwed into the first threaded bore, the first flanks are drawn together;
a second threaded element, having a threaded section and a handle extended from the threaded section, the threaded section being configured to pass through the second through hole and then engage with the second threaded bore, such that as the second threaded element is screwed into the second threaded bore, the second flanks are drawn together, wherein by screwing at least one of the first and second threaded elements, the carriage is adjusted toward a clamping position from an initial, release position; and
a toolrest, having a substantially horizontal toolrest portion and a shaft extending downward from the toolrest portion, the shaft being inserted into the retaining socket, the shaft being allowed to move axially within the retaining socket when the carriage is at the release position, and the shaft being disallowed to move axially within the retaining socket when the carriage is at the clamping position.

2. The toolrest mechanism of claim 1, wherein the second through hole and the second threaded bore of the second flanks are located corresponding to a center of the vertical length of the slot.

3. The toolrest mechanism of claim 1, wherein each of the slot has a bottom thereof formed as a circular groove whose diameter is greater than a width of the rest part of the slot, or a distance between the clamping elements.

4. The toolrest mechanism of claim 1, wherein the retaining socket between the clamping elements has a circular periphery, so as to facilitate the shaft rotating within the retaining socket when the carriage is at the release position.

5. The toolrest mechanism of claim 1, wherein the first threaded element also has a handle for facilitating force application.

6. The toolrest mechanism of claim 1, wherein an included angle defined between the threaded section and the handle of the second threaded element is between 100 and 110 degrees.
